(19) United States
(12) Patent Application Publication
(10) Pub. No.: US 2024/0130385 A1
(43) Pub. Date: Apr. 25, 2024

(54) WHIPPABLE COMPOSITION II

(71) Applicant: Oatly AB, MALMÖ (SE)

(72) Inventors: Michael Molino, New York, NY (US); Joakim Bjunö, New York, NY (US); Sofia Ehlde, MALMÖ (SE); Karin Petersson, MALMÖ (SE)

(21) Appl. No.: 18/277,216

(22) PCT Filed: Feb. 15, 2021
(86) PCT No.: PCT/US2021/018116

§ 371 Date: Aug. 13, 2023

(51) Int. Cl. A23C 11/10; A23L 9/20; A23L 33/105; A23L 33/185

(52) U.S. Cl. CPC A23C 11/10; A23L 9/24; A23L 33/105; A23L 33/185

(57) ABSTRACT

A non-dairy whippable food composition has vegetable fat in an amount of 10 to 40 percent by weight of the composition, an oat-derived material including dry matter in an amount of 1 to 10% by weight of the composition, water, and a stabilizer including monoglycerides and/or diglycerides. The vegetable fat in the composition is non-hydrogenated vegetable fat.

### FIELD OF THE INVENTION

The invention relates to a non-dairy whippable food composition and a process for manufacturing a non-dairy whippable food composition.

### BACKGROUND OF THE INVENTION

The demand for dairy substitute products is and has been increasing over several years, due to a desire from consumers to exclude or reduce the amount of animal and dairy products from their diet.

There is a further demand and need for dairy substitute products taking sustainability into account as well as health aspects, fueled by an interest in sustainability, vegetarianism, veganism as well as for improved health.

Non-dairy whippable creams and whipping cream substitutes are available. Often non-dairy whippable creams contain hydrogenated vegetable oils, which may contain trans fats. Examples include hydrogenated palm kernel oil and palm oil. The oil palm (Elaesis guineensis) grows naturally in tropical West Africa and is closely related to the coconut palm. For environmental reasons it would be desirable to avoid or minimise use of palm oil.

It is a problem to achieve shelf-life stability, good whippability, and/or good foam stability with whipping cream substitutes. There is thus a need for a non-dairy whippable cream free from hydrogenated fat and/or free from palm oils.

### SUMMARY OF THE INVENTION

One object of the invention is to alleviate, at least in part, the drawbacks of the prior art. One object of the invention is to provide a non-dairy whippable food composition. One object of the invention is to provide a more stable non-dairy whippable food composition, such as with reduced coalescence during shelf life. One object of the invention is to provide a non-dairy whippable food composition free from hydrogenated fat.

According to one aspect of the invention, there is provided a non-dairy whippable food composition, comprising: vegetable fat present in an amount of 10% to 40%, by weight of the composition; an oat-derived material comprising dry matter in an amount of 1% to 10%, by weight of the composition; water; and a stabiliser comprising monoglycerides and/or diglycerides, wherein the vegetable fat is non-hydrogenated vegetable fat.

The combination of non-hydrogenated vegetable fat, oat-derived material and the monoglycerides and/or diglycerides makes the composition susceptible to whipping up, allowing for non-dairy whipped cream. Mono- and di-glycerides may act in displacing protein and may promote partial coalescence. The composition may be characterised as being free from palm oil, and free from soy and dairy. The non-hydrogenated vegetable fat may comprise at least 50% non-hydrogenated coconut oil.

It is preferred that the composition does not contain any ingredients of animal origin.

The composition may comprise further emulsifiers, such as, for example, mustard, lecithin, polysorbates, carrageenan, guar gum, locust bean gum and canola oil.

The vegetable fat may be present in an amount of 15% to 25%. Such amounts of the vegetable fat provide excellent properties to the whippable composition and may be combined with the other ingredients and levels of ingredients of the composition.

The vegetable fat may contain more than 50% saturated fat, such as more than 60% saturated fat, such as more than 70% saturated fat, such as more than 80% saturated fat. The vegetable fat may contain less than 95% saturated fat, such as less than 90% saturated fat, such as less than 85% saturated fat, such as less than 80% saturated fat. The vegetable fat may contain 50 to 95% saturated fat, such as 60 to 95% saturated fat, such as 70 to 90% saturated fat, such as 75 to 90% saturated fat.

Water may be present in an amount of 40 to 85%, such as 40 to 60%, by weight of the composition.

The pH of the composition may be between 6.5 and 8, such as between 7 and 7.5. The composition may further comprise a buffering agent. The buffering agent may be used to provide desirable pH of the composition.

The oat-derived material may have been obtained from treatment of oats comprising treatment with amylase, optionally followed by fermentation. The oat-derived material may be a liquid oat base, such as an oat drink, or an oat syrup. The oat-derived material may be in dry form, eg. in form of a powder. Other types of oat-derived materials may also be used.

The composition may further comprise maltodextrin. Maltodextrin may be present in an amount of 1-10%, such as 1-5%, such as 2-4%, such as 3% of the food composition. Maltodextrin binds water and may thus contribute to preventing water leakage after product is already whipped.

The stabiliser may further comprise hydroxypropylmethyl cellulose (HPMC). HPMC improves whipped cream firmness in the composition.

The composition may further comprise gellan gum. It has unexpectedly been discovered that gellan gum in combination with other ingredients of the composition contributes to binding water and prevents water separation through shelf-life.

The composition may further comprise Quillaia extract. The Quillaia extract may be present in the composition in an amount of 0.6% or below as dry weight by weight of the composition, such as 0.00002% to 0.6%, or 0.0002 to 0.1%. According to one example, the Quillaia extract may be present in the composition in an amount of 0.001 to 0.002% as dry weight by weight of the composition, for example 0.0015%.

The Quillaja extract may be present in the composition in a diluted extract, for example having approximately 20-22% dry weight in an amount of 0.0001% to 3%, such as 0.001% to 0.5%, such as 0.001% to 0.01%, such as 0.005% to 0.009%, such as 0.007%, by weight of the composition.

The Quillaia extract may be of Type 1 Quillaia extract or Type 2 Quillaia extract, or combinations thereof.

The stabiliser may further comprise a vegetable protein, such as chickpea protein. Chickpea protein is believed to bind to the surface of oil and may contribute to prevent coalescence. Coalescence may give negative effects, such as low efficiency or low colloidal stability of the emulsion. The combination of oat-derived material, the Quillaja extract and the stabilizer comprising chickpea protein is particularly advantageous.

The vegetable fat may further comprise rapeseed oil and/or shea butter. The vegetable fat may comprise a mixture of non-homogenized coconut oil and shea butter, such as a mixture comprising 50% coconut oil and 10-50% shea butter.

The vegetable fat may comprise at least 70% coconut oil by weight of the vegetable fat.

The vegetable fat may, such as in an alternative aspect, comprise a mixture of hydrogenated coconut oil and rapeseed oil, such as a mixture comprising 50% hydrogenated coconut oil and 10-50% rapeseed oil.

According to another aspect of the invention, there is provided a process for manufacturing of non-dairy whippable food composition, comprising providing an aqueous liquid comprising an oat-derived material comprising dry matter in an amount of 1% to 10% by weight of the composition; providing a vegetable fat; (a) heating the vegetable fat to 50-70° C.; (b) adding the vegetable fat to the aqueous liquid during a time period of 25 to 55 minutes, such that an emulsion is formed comprising a vegetable fat phase and an aqueous phase, wherein the vegetable fat present in an amount of 10 to 40% by weight of the whippable food composition; (c) cooling the obtained emulsion to 35-45° C. at a rate of 5-10° C. per second and subsequently to 6° C. at a rate of 5-10° C. per second, wherein the vegetable fat is present in an amount of 10 to 40%, such as 15-25% by weight of the composition.

Commonly, addition of fat to aqueous liquid is made during around 10 minutes to create an emulsion. In contrast, in the process according to the invention, the addition of the vegetable fat to aqueous liquid may be made more slowly, during 25 to 55 minutes, such as during 30 to 50 minutes, such as during 35 to 48 minutes. The rather fast two step cooling of the obtained emulsion in step (e), first to 35-45° C. at a rate of 5-10° C. per second, and subsequently to 6° C. at a rate of 5-10° C. per second, helps the vegetable fat crystallize properly. The heating typically happens in two heat exchangers, one gets product to 40° C., the other down to 6° C.

The aqueous liquid comprising an oat-derived material may be provided as a liquid oat base having 10-20% dry matter by weight or an oat syrup having 60-85% dry matter by weight.

As an example, if a batch size of 11000 kg of whippable non-dairy food composition is prepared, 2500 kg of vegetable fat may be added at 4.000 Litres per hour. The typical density for oil is around 0.9 kg per Litre, translating to 2500 kg of vegetable fat being added during a time period of around 40 minutes.

The process may further comprise, between steps (d) and (e), subjecting the emulsion to a heat treatment optionally followed by homogenization. The heat treatment may be a an Ultra-high Temperature processing. The homo-genization may have 2 stages, a first at 100-170 Bar, such as 140 to 160 Bar, such as 145 to 155 Bar, such as 150 bar, and a second at 30 to 70 Bar, such as 40 to 60 Bar, such as 45 to 55, bar, such as 50 bar and a temperature at 50-90° C., such as 60-80° C., such as 65-77° C., such as 68 to 74° C., such as around 70° C.

The process may be for manufacturing the non-dairy whippable food composition according to the invention.

Thus, features from a composition aspect of the invention may be used in a process aspect of the invention, and vice versa.

### DETAILED DESCRIPTION OF THE INVENTION

The present invention will now be described more fully hereinafter. This invention may, however, be embodied in many different forms and should not be construed as limited to the embodiments set forth herein; rather, these embodiments are provided for thoroughness and completeness, and fully convey the scope of the invention to the skilled person. Although individual features may be included in different embodiments, these may possibly be combined in other ways, and the inclusion in different embodiments does not imply that a combination of features is not feasible. In addition, singular references do not exclude a plurality. In the context of the present invention, the terms “a”, “an” does not preclude a plurality.

The present inventive concepts are, at least in part, based on unexpected realizations including that by manufacturing of a non-dairy whippable food composition as defined by the appended claims and examples and embodiments described herein, i.e. a non-dairy whippable food composition comprising a vegetable fat, wherein the vegetable fat is non-hydrogenated vegetable fat, a content of an oat-derived material and a stabilizer comprising monoglycerides and/or diglycerides, a non-dairy whippable food composition may be provided having beneficial or desirable properties.

The presence of the oat-derived material in the composition with resulting benefits have been made possible. Thus, whippable compositions according to the present inventive concept, are achievable with desirable whipping properties while at the same time allowing at least contributing to benefits associated with, for example, beta glucan, which may be present in oat-derived material. According to the present inventive concepts it is further possible to combine oat-derived material and other ingredients, which together form a desirable non-dairy whippable food composition, which composition further may be environmentally sustainable.

Thus, the vegetable edible fat composition according to inventive concepts and embodiments herein may be tailored such that the composition may be characterized by being environmentally sustainable and/or which may provide benefits associated with oats, particularly when combined in diet with other sources of e.g. oat derived material, as compared to alternative compositions.

By whippable food composition, as used herein, is intended a product that may be aerated, for example by whipping, to produce a foam. It is desirable that the foam is maintained or stable after for several hours aeration.

The whippable food composition according to embodiments, may be described as a whipping cream substitute.

Non-dairy, as used herein, is meant a composition essentially free from dairy components.

In addition to being described as a non-dairy whippable food composition, the composition may be described as a plant-based, a vegetable, a vegan, and/or a vegetarian non-dairy whippable food composition. The whippable food composition may be totally free from animal ingredients. However, the non-dairy whippable food composition may contain additives derived from animal sources, and still be according to embodiments described herein.

According to one aspect of the invention, there is provided a non-dairy whippable food composition, comprising: vegetable fat present in an amount of 10% to 40%, by weight of the composition; an oat-derived material comprising dry matter in an amount of 1% to 10%, by weight of the composition; water; and a stabiliser comprising monoglycerides and/or diglycerides, wherein the vegetable fat is non-hydrogenated vegetable fat.

The combination of ingredients of the composition provides desirable properties to the composition. Such a composition may, for example, be free from palm oil or fat, gluten and/or soy. It has further been realised that the composition may be realised with desirable properties, including for example good whipping properties, stable foam, and long shelf life stability. The beneficial properties may be achieved for reasons including the combination of oat-derived material, non-hydrogenated vegetable fat, and a stabiliser comprising monoglycerides and/or diglycerides. The combination of non-hydrogenated vegetable fat, oat-derived material and the monoglycerides and/or diglycerides makes the composition susceptible to whipping up, allowing for non-dairy whipped cream. It is believed that mono- and di-glycerides may act in displacing protein and may promote at least partial coalescence. Further, the composition may be characterised as being free from palm oil, and free from soy and dairy. It is a further benefit, that the whippable product can be provided with a content of oat-derived material.

The non-hydrogenated vegetable fat may comprise at least 50% non-hydrogenated coconut oil. In combination with other ingredients of the composition, and in particular in combination with the monoglycerides and/or diglycerides, the non-hydrogenated coconut oil allow a desirable non-dairy whippable food composition to be manufactured characterised by having stable properties. Further, the vegetable fat may comprise at least 70% coconut oil by weight of the vegetable fat. The coconut oil is non-hydrogenated coconut oil.

The composition may be in form of an emulsion comprising a fat phase and an aqueous phase.

It is preferred that the composition does not contain any ingredients of animal origin, or that is free from ingredients of animal origin.

The composition may comprise further emulsifiers, such as, for example, mustard, lecithin, polysorbates, carrageenan, guar gum, locust bean gum and canola oil.

The composition may further comprise other ingredients and additives, for example salt, colouring agents, flavourings, vitamins etc.

The vegetable fat may contain more than 50% saturated fat, such as more than 60% saturated fat, such as more than 70% saturated fat, such as more than 80% saturated fat. The vegetable fat may contain less than 95% saturated fat, such as less than 90% saturated fat, such as less than 85% saturated fat, such as less than 80% saturated fat. The vegetable fat may contain 50 to 95% saturated fat, such as 60 to 95% saturated fat, such as 70 to 90% saturated fat, such as 75 to 90% saturated fat.

Water may be present in an amount of 40 to 85%, such as 40 to 60% by weight of the composition. The water may be expressed as the total water of the composition, e.g. comprising water added as free water during manufacturing of the composition, and any water present with ingredients of the composition, which may be the case for example if liquid or aqueous oat base is used.

The pH of the composition may be between 6.5 and 8, such as between 7 and 7.5.

The composition may further comprise a buffering agent, to provide suitable pH of the composition. The buffering agent may suitably be a suitable food acidity regulator. For example, the buffering agent may be selected from the group consisting of, such as rac-lactic acid, acetic acid, adipic acid, citric acid, fumaric acid, malic acid or a suitable salt thereof, such as a sodium salt, a potassium salt, ammonium salt, or a magnesium salt thereof. Typical buffering agents include rac-lactic acid, acetic acid, adipic acid, citric acid, fumaric acid, malic acid, monosodium fumarate, potassium acetate, sodium citrate, potassium hydrogencarbonate, disodium fumarate, disodium malate, ammonium hydroxide, ammonium acetate, magnesium citrate, sodium lactate, and ferric ammonium citrate, for example sodium citrate.

The oat-derived material may be an oat base obtained from treatment of oats such that at least a portion of starch from the oats are solubilized or degraded. For example, an aqueous oat slurry of micronized oats may be treated such that at least a portion of starch from the micronized oats are degraded, which may be performed by contacting the aqueous oat slurry with amylase. Other enzymes may be used alternatively or in combination. For example, one or more of α-amylase and β-amylase may be used. The oats may suitable be micronized oats.

Thus, the oat-derived material may be obtained from treatment of oats comprising treatment with amylase. Optionally the treatment of oats may be followed by fermentation.

The oat-derived material may be a liquid oat base or oat syrup. The liquid oat base may be what may be referred to as an oat drink, or what is sometimes referred to as an oat milk. Typically, the oat-base or oat drink may comprise sugars 2-8%, fibres 0.2-3% (out of which 0.1-1% of the oat drink are beta glucans), fat 0.5-2.5%, and proteins 0.5-2.5%. The oat syrup may be described as an oat base rich in sugars but low in fibre. The dry matter of the liquid oat base may be for example 10-20% by weight of the liquid oat base, for example 14-16% by weight, which may be typical levels for oat drinks. The dry matter of the oat syrup may alternatively or in addition be higher, for example 60-85% by weight of the oat syrup, for example 70-80% by weight. Further, the oat-derived material may be in dry form or as a powder.

It shall be realised and appreciated that the oat-derived material, such as liquid oat base, oat drinks, oat syrups or in dry forms, may be provided during manufacturing of the composition more or less or without dilution with water or aqueous liquid and with or without further addition of water, as long as the total amount of water in the composition is suitable for the composition or in accordance with embodiments discussed herein.

For whippable compositions comprising sugar, 50% or more, such as 60% or more, or 90% or more, by weight of the sugar of the composition, may be maltose. The maltose may be from degradation of starch from oats material, for example using enzymatic degradation, for example using amylase, such as α- or β-amylase.

The composition may further comprise maltodextrin. Maltodextrin may be present in an amount of 1-10%, such as 1-5%, such as 2-4%, for example 3% of the food composition. Maltodextrin as used in the composition, is believed to bind water and thus act in contributing to preventing water leakage from the composition, and in particular contribute to providing stability to the composition after being whipped or to add stability to a foamed or whipped composition.

The stabiliser may further comprise hydroxypropylmethyl cellulose (HPMC). HPMC improves whipped cream firmness properties to the composition.

The composition may further comprise gellan gum. It has unexpectedly been discovered that gellan gum in combination with other ingredients of the composition contributes to binding water and prevents long term water separation, e.g. through shelf-life.

The composition may further comprise Quillaia extract. A combination of ingredients of the composition, including the quillaja extract, together with chickpea protein, unexpectedly contributes at least in part to stabilise the vegetable fat. The vegetable fat is kept from coalescing in shelf life, at least in part believed to be one result of formed micelles around oil droplets and thereby keeps vegetable fat separate through electrostatic repulsion. The Quillaja extract may be Type 2, which is obtained either by chromatographic separation or ultrafiltration of the aqueous extraction of the milled inner bark or of the wood of pruned stems and branches of Quillaja saponaria Molina (family Rosaceae). It contains triterpenoid saponins (quillaia saponins, QS) consisting predominantly of glycosides of quillaic acid. Polyphenols and tannins are minor components. Some sugars and calcium oxalate will also be present. Quillaia extract (Type 2) is available commercially as a liquid product or as a spray-dried powder that may contain carriers such as lactose, maltitol or maltodextrin. The liquid product is usually preserved with sodium benzoate or ethanol. C.A.S. number 68990-67-0. The Quillaja extract may be Q-NATURALE® 200 V. The Quillaja extract, for example Q-NATURALE® 200 V, may be extracted by a natural process and may be referred to as a naturally-derived liquid emulsifier. Typically, the Quillaia extract may be present in the composition in an amount of 0.6% or below by dry substance by weight of the composition, such as 0.00002% to 0.6%, or 0.0002 to 0.1%. According to one example, the Quillaia extract may be present in the composition in an amount of 0.001 to 0.002% as dry weight by weight of the composition, for example 0.0015%.

The Quillaja extract may be present in the composition in a diluted extract, for example having approximately 20-22% dry weight, in an amount of 0.0001% to 3%, such as 0.001% to 0.5%, such as 0.001% to 0.01%, such as 0.005% to 0.009%, such as 0.007%, by weight of the composition.

The Quillaia extract may be of Type 1 Quillaia extract or Type 2 Quillaia extract, or combinations thereof. Other types of Quillaia extracts may also be used alone or in combination.

The stabiliser may further comprise a vegetable protein, such as chickpea protein. Chickpea protein is believed in this context to bind to the surface of oil and may contribute to prevent coalescence. Coalescence may give negative effects, such as low efficiency or low colloidal stability of the emulsion. The combination of oat-derived material, the Quillaja extract and the stabilizer comprising chickpea protein is particularly advantageous.

The vegetable fat may further comprise rapeseed oil and/or shea butter. The vegetable fat may comprise a mixture of non-homogenized coconut oil and shea butter, such as a mixture comprising 50% coconut oil and 10-50% shea butter.

In an alternative aspect, the vegetable fat may comprise hydrogenated fat. For example, a mixture of hydrogenated coconut oil and rapeseed oil, such as a mixture comprising 50% hydrogenated coconut oil and 10-50% rapeseed oil.

According to another aspect of the invention, there is provided a process for manufacturing of non-dairy whippable food composition, comprising providing an aqueous liquid comprising an oat-derived material comprising dry matter in an amount of 1% to 10% by weight of the composition; providing a vegetable fat; (a) heating the vegetable fat to 50-70° C.; (b) adding the vegetable fat to the aqueous liquid during a time period of 25 to 55 minutes, such that an emulsion is formed comprising a vegetable fat phase and an aqueous phase, wherein the vegetable fat is present in an amount of 10 to 40% by weight of the whippable food composition; (c) cooling the obtained emulsion to 35-45° C. at a rate of 5-10° C. per second, such as 5, 6, 7, 8, or 10° C. per second, and subsequently to 6° C. at a rate of 5-10° C. per second, such as 5, 6, 7, 8, or 10° C. per second, wherein the vegetable fat is present in an amount of 10 to 40 percent, such as 15-25% by weight of the composition.

The cooling step (c) may be cooling the obtained emulsion to 35-45° C. at a rate of 6-9° C. per second, such as 6-8° C. per second, or 5-8° C. per second, or 5-7° C. per second, and subsequently to 6° C. at a rate of 6-9° C. per second, such as 6-8° C. per second, or 5-8° C. per second, or 5-7° C. per second.

Commonly, addition of fat to aqueous liquid may be made during around 10 minutes to create an emulsion. In contrast, in the process according to the invention, the addition of the vegetable fat to aqueous liquid may be made more slowly, during 25 to 55 minutes, such as during 30 to 50 minutes, such as during 35 to 48 minutes. The rather fast two step cooling of the obtained emulsion in step (e), first to 35-45° C. at a rate of 5-10° C. per second, and subsequently to 6° C. at a rate of 5-10° C. per second, helps the vegetable fat crystallize properly. The heating typically happens in two heat exchangers, one gets product to 40° C., the other down to 6° C.

The process for manufacturing of non-dairy whippable food composition, may comprise: (a) providing an aqueous liquid comprising an oat-derived material comprising dry matter in an amount of 1% to 10% by weight of the composition; (b) providing a vegetable fat comprising at least 50% coconut oil by weight of the vegetable fat; (c) heating the vegetable fat to 50-70° C.; (d) adding the vegetable fat to the aqueous liquid during a time period of 25 to 55 minutes, such that an emulsion is formed comprising a vegetable fat phase and an aqueous phase, wherein the vegetable fat is present in an amount of 10 to 40% by weight of the whippable food composition; (e) cooling the obtained emulsion to 35-45° C. at a rate of 5-10° C. per second and subsequently to 6° C. at a rate of 5-10° C. per second, wherein the composition further comprises a stabiliser comprising monoglycerides and/or diglycerides, and wherein the vegetable fat is present in an amount of 10 to 40 percent, such as 15-25% by weight of the composition.

The aqueous liquid comprising an oat-based material may be provided as a liquid oat base having 10-20% dry matter by weight or an oat syrup having 60-85% dry matter by weight.

As an example, if a batch size of 11000 kg of whippable non-dairy food composition is being made, 2500 kg of vegetable fat is added at 4.000 Litres per hour. The typical density for oil is around 0.9 kg per Litre, meaning that the 2500 kg of vegetable fat is added during a time period of around 40 minutes.

The process may further comprise, between steps (d) and (e), subjecting the emulsion to a heat treatment optionally followed by homogenization. The heat treatment may be a an Ultra-high Temperature processing. The homogenization may have 2 stages, the first at 100-170 Bar, such as 140 to 160 Bar, such as 145 to 155 Bar, such as 150 bar and the second at 30 to 70 Bar, such as 40 to 60 Bar, such as 45 to 55, bar, such as 50 bar and a temperature at 50-90° C., such as 60-80° C., such as 65-77° C., such as 68 to 74° C., such as around 70° C.

The process may be for manufacturing the non-dairy whippable food composition according to the invention.

Features from composition aspect of the invention may be used in the the process aspect of the invention and vice versa.

### EXAMPLE

An example of manufacturing of a non-dairy whippable food composition according to an embodiment will now be discussed in an attempt to improve an understanding of present inventive concepts.

In this example, the oat-derived material is a liquid oat base of 15% DS. The liquid oat base is for this example may be obtained from treatment of oats comprising treatment with amylase, for example as has been described in patent No. EP 1 383 396 B1. The liquid oat base is mixed with water to produce an aqueous phase comprising oat-derived material, which aqueous phase is heated to 50° C. Dry ingredients are mixed: Stabilizer blend, maltodextrin, gellan gum and salt. The mixture of dry ingredients is added to the oat-derived material mixture under high shear. After approximately 5 minutes mixing quillaia extract is added.

Vegetable fat is heated to 60° C. and slowly (during around 40 minutes) added to the stirred aqueous mixture. The resulting mixture is re-circulated over a mixer for a few minutes at a temperature at about 55-60° C. The mixture is then subjected to Ultra-high-temperature processing. Subsequent homogenization is made in 2 stages, at 150 bar and at 50 bar at a temperature around 70° C. The homogenized mixture is first cooled to 40° C. at a rate of 5-10° C. per second and then to 6° C. at a rate of 5-10° C. per second. The entire batch is filled in a tank before starting to fill the composition into containers. The proportions of the ingredients are according to the recipes in Table 1.

TABLE 1

| | Recipe | | | | |
|---|---|---|---|---|---|
| | 1 | 2 | 3 | 4 | 5 |
| Ingredient | Amounts (% by weight) | | | | |
| Water | 52.06 | 52.06 | 52.06 | 52.06 | 52.07 |
| Oat Base | 20.41 | 20.41 | 20.41 | 20.41 | 20.41 |
| Coconut oil | 22 | | | | |
| (Akoplanet | | | | | |
| CNO 16-001) | | | | | |
| Shea butter | 0 | 22 | 22 | | |
| Hydrogenated coconut | | | | 22 | 22 |
| oil and rapeseed oil | | | | | |
| (AkoPlanet PBW 119-28) | | | | | |
| Maltodextrin | 3 | 3 | 3 | 3 | 3 |
| (GLOBE 15 DE) | | | | | |
| 3-23594 Stabilizer | 2.4 | 2.4 | 2.4 | 2.4 | 2.4 |
| Blend | | | | | |
| Gellan gum | 0.02 | 0.02 | 0.02 | 0.02 | 0.02 |
| (Kelcogel HA-B) | | | | | |
| Salt | 0.1 | 0.1 | 0.1 | 0.1 | 0.1 |
| Quillaja extract | 0.007 | 0.007 | 0.007 | 0.007 | |
| (Q-Naturale 200V | | | | | |

The exemplifying stabilizer blend contains: Maltodextrin, chickpea protein (appr. 12%), mono- and di-glycerides (appr. 12%), sodium citrate, hydroxypropylmethyl cellulose.

1. A non-dairy whippable food composition, comprising:
vegetable fat in an amount of 10 to 40 percent by weight of the composition;
an oat-derived material comprising dry matter in an amount of 1 to 10% by weight of the composition;
water; and
a stabiliser comprising monoglycerides and/or diglycerides,
wherein the vegetable fat is non-hydrogenated vegetable fat.

2. The food composition according to claim 1, wherein the non-hydrogenated vegetable fat comprises at least 50% coconut oil.

3. The food composition according to claim 1, wherein the water is present in an amount of 40 to 60% by weight of the composition.

4. The food composition according to claim 1, wherein the pH of the composition is between 6.5 and 8, such as between 7 and 7.5.

5. The food composition according to claim 1, wherein the oat-derived material has been obtained from treatment of oats comprising treatment with amylase, optionally followed by fermentation.

6. The food composition according to claim 1, wherein the oat-derived material is a liquid oat base or oat syrup.

7. The food composition according to claim 1, wherein the composition further comprises maltodextrin.

8. The food composition according to claim 1, wherein the stabiliser further comprises hydroxypropylmethyl cellulose.

9. The food composition according to claim 1, wherein the composition further comprises gellan gum.

10. The food composition according to claim 1, wherein the composition further comprises Quillaia extract.

11. The food composition according to claim 1, wherein the stabiliser further comprises a vegetable protein, such as chickpea protein.

12. The food composition according to claim 1, wherein the vegetable fat further comprises rapeseed oil and/or shea butter.

13. The food composition according to claim 1, wherein the vegetable fat comprises at least 70% coconut oil by weight of the vegetable fat.

14. A process for manufacturing of a non-dairy whippable food composition, the process comprising:
(a) providing an aqueous liquid comprising an oat-derived material comprising dry matter in an amount of 1% to 10% by weight of the composition;
(b) providing a non-hydrogenated vegetable fat;
(c) heating the vegetable fat to 50-70° C.;
(d) adding the vegetable fat to the aqueous liquid during a time period of 25-55 minutes, such that an emulsion is formed comprising a vegetable fat phase and an aqueous phase, wherein the vegetable fat present in an amount of 10 to 40% by weight of the whippable food composition;
(e) cooling the obtained emulsion to 35-45° C. at a rate of 5-10° C. per second and subsequently to 6° C. at a rate of 5-10° C. per second,
wherein the composition further comprises a stabiliser comprising monoglycerides and/or diglycerides.

15. The process according to claim 14, further comprising, between steps (d) and (e), subjecting the emulsion to a heat treatment.
